(19) United States
(12) Patent Application Publication
(10) Pub. No.: US 2015/0310276 A1
(43) Pub. Date: Oct. 29, 2015

(54) METHOD FOR THE AUTOMATIC CORRECTION OF ALIGNMENT ERRORS IN STAR TRACKER SYSTEMS

(71) Applicant: Jena Optronik GmbH, Jena (DE)

(72) Inventors: Roland Strietzel, Sohland (DE); Klaus Michel, Jena (DE); Dietmar Ratzsch, Wogau (DE)

(21) Appl. No.: 14/649,799

(22) PCT Filed: Dec. 2, 2013
(86) PCT No.: PCT/DE2013/100403

§ 371 Date: Jun. 4, 2015

(30) Foreign Application Priority Data
Dec. 4, 2012 (DE) 10 2012 111 752.7

(51) Int. Cl. G06K 9/00; G06K 9/52; G06K 9/62; G06T 7/00

(52) U.S. Cl. CPC G06K 9/00624; G06T 7/004; G06K 9/52; G06K 9/6201

(57) ABSTRACT

A method for the automatic correction of alignment errors in individual star trackers (R, S) of star tracker systems (1) is provided. The correction of orientation errors is necessary whenever it is not possible to mount the star trackers of the star tracker system on a shared stable block of a platform. Orientation errors can arise due to installation deviations and deformation of the platform, for instance, caused by mechanical loads or temperature fluctuations. A star tracker (R) that is attached in a very stable manner to the platform serves as the reference tracker. The orientation that it measures constitutes the reference information. An error signal and an orientation matrix are derived from the measured orientation of the other star trackers, thereby effectuating the correction of the coordinate systems of the star trackers that are to be corrected, and thus of their measured quantities. The resulting orientation as the starting quantity of the star tracker system is then calculated on the basis of the orientation information of the reference tracker and of the other star trackers. The linking of the measured results of the individual star trackers can take place on the level of the star vectors of a star catalog, on the level of preprocessed tracker signals or on the level of the quaternions and/or on the level Euler angles.

The invention relates to a method for the automatic correction of alignment errors in tracker systems consisting of several star trackers.

### BACKGROUND

European patent application EP 1 111 402 A1 discloses a tracker system comprising three star trackers with fields of vision aligned in different directions, whereby each star tracker detects star positions and outputs them to a central evaluation unit where the orientation of the tracker system is determined and the orientation of the flying object is determined on the basis of the alignment of the tracker system with respect to a flying object. In order to avoid additional errors, the star cameras are situated on a solid block. No studies have been conducted on the influence of alignment errors of the viewing directions of the individual star trackers. Practically no alignment errors occur if the trackers are mounted on a stable block and are adjusted by means of known optical methods. The measuring accuracy of the tracker system drops considerably if the alignment errors fall within the order of magnitude of the measuring accuracy of the star positions.

Due to the different designs of flying objects, in actual practice, it is not always possible to mount the star trackers on a stable block, as a result of which the individual trackers have to be arranged at different places on the platform while maintaining the requisite viewing directions. Alignment errors then occur primarily due to deformations caused by mechanical loads or temperature fluctuations. Since the orientation of the flying object is decisive for fulfilling the envisaged mission, a high degree of measuring accuracy and reliability is required of the tracker system. In the case of large objects, the exact optical alignment can also be problematic.

Since determining the orientation is crucial for the realization of planned missions, it is very important to avoid alignment errors of individual star trackers, and thus to improve the measuring accuracy of such star systems. The star trackers consist of a lens, a light-sensitive matrix detector and an evaluation unit for calculating orientation information about the flying object on the basis of a comparison of the detected constellation sections to a star catalog that is based on an inertial system. Through the use of several star trackers in a star system, the measuring accuracy of the orientation (attitude) can be significantly increased if the information from the individual trackers is appropriately linked.

The determination of the orientation of flying objects such as, for instance, satellites, space stations, space shuttles and the like is carried out by means of a method that evaluates the data from one or more star trackers which, on the basis of a prescribed field of vision, are aligned with a section of the night sky, referred to below as a constellation section, and which, by means of image recognition, then compare the constellation section detected in a matrix detector to a star catalog kept in a storage unit. Once the constellation section has been identified, the orientation of the flying object is determined in that, for example, the QUEST algorithm uses the measured star vectors and the data from the star catalog to determine the Euler angles and/or the quaternions, and the latter are transformed by the coordinate system of the star tracker system onto the coordinate system of the flying object. The more stars are evaluated in the tracker system, the greater its measuring accuracy. The alignment of the individual star trackers in different viewing directions accounts for the fact that the errors of the three spatial angles (Euler angles) of the star tracker system are of about the same magnitude and are minimal.

### SUMMARY OF THE INVENTION

It is an object of the present invention to provide a star tracker system for determining the orientation which exhibits improved accuracy and in which alignment errors of the star trackers that occur are automatically corrected.

The present invention provides a method for determining the orientation of a flying object, said method comprising a tracker system with several star trackers that each use a lens and a light-sensitive matrix detector to detect constellation sections and that have the same or different fields of vision, different viewing directions, and an evaluation unit for calculating the orientation information about the flying on the basis of a comparison of the detected constellation sections to a star catalog, whereby the star trackers are in signal communication with each other via a bus system. Each individual star tracker is preferably capable of autonomously carrying out a determination of the orientation.

When it comes to carrying out the method, it has proven to be advantageous for a star tracker to be specified as the reference tracker in the form of a master tracker. The star tracker to be selected as the master tracker should be one that has a very stable and defined attachment to the platform of the flying object. According to the invention, the objective of correcting misalignments is achieved as follows. A star tracker, which is joined in a very stable manner to the platform of the flying object and to its coordinate system, becomes the reference or master tracker. Its measured results serve as the reference quantities for another tracker or for several trackers.

The coordinate systems of the individual star trackers result from the x-y plane of the matrix detector and from the z-axis in the viewing direction. A master coordinate system constitutes the coordinate system of the star tracker system. For the most part, it does not coincide with the coordinate system of the master tracker. A coordinate transformation allows the orientation data of the individual star trackers of the star tracker system to be transformed into the master coordinate system. By the same token, the transformation of the master coordinate system into the coordinate system of the flying object can be carried out by means of an orientation matrix, for example, in the form of a direction cosine matrix, so that the flying object receives the momentary and continuously corrected orientation in the form of Euler angles and/or quaternions.

The individual star trackers preferably comprise a lens, the matrix detector, a module for calculating the star vectors and eliminating undesired signals, a module with a star catalog for identifying the stars, a module for calculating the orientation information, preferably on the basis of the QUEST algorithm, a bus control unit with a bus interface that selects and encodes the information for the bus system and that controls the bus system, and the output module for the orientation information of the master coordinate system or of the flying object according to the underlying coordinate system as well as a control unit for correcting alignment errors. Moreover, each star tracker has a clock-pulse generator and a power supply unit. In this context, the objective is to create a star tracker system having high reliability and precision. Normally, the star trackers of the star tracker system operate in parallel with their modules, that is to say, with hot redundancy. In order to enhance the precision of the star tracker system, the orientation information of the star trackers is preferably combined in the master tracker via the bus system. Moreover, the possibility exists to compare the orientation information from each of the individual star trackers to each other in order to ascertain possible misalignments of individual star trackers. With an eye towards an efficient and cost-effective production, the star trackers of the star tracker system are preferably structured identically and can also be individually deployed.

The orientation data of the star tracker that is to be corrected is compared to that of the reference tracker and the deviations are processed in a module of the evaluation unit. The orientation data of both star trackers have to relate to the same coordinate system (coordinate system of the reference tracker, master coordinate system of the tracker system, coordinate system of the flying object). The module generates a correction signal for the star tracker in question. Several possibilities exist for the correction of misalignments, for instance, mechanical alignment, provided that the star trackers in question are arranged on the platform in such a way that they can be aligned along the three spatial axes by means of remote control. This, however, is the exception and is correspondingly complex. Preferably, a misalignment is compensated for by a correction on different data-processing levels, for instance, a correction on the level of the star vector, a correction on the level of processed star vectors and/or a correction of the orientation information that takes place on the level of the Euler angles and/or the quaternions, until the orientation information yields a prescribed error minimum in a comparison of the erroneous star trackers to the reference tracker.

The first data-processing level is, for example, the measured star vectors, namely, unit vectors in the tracker coordinate system that are detected with the matrix detector. The data is preferably simply preprocessed in that sources of extraneous light are segregated. The data has undergone an analog-digital conversion and, for example, a sub-pixel interpolation has already been carried out. The scope of the data that is to be transmitted on this level depends on the number of stars that are observed in the star tracker in question. The correction signal, which has the form of an orientation matrix, transforms all star vectors as if they were being measured by the correctly aligned star tracker,

v_{ic}=A_{c}vᵢ, i=1, . . . N, (1)

with the correction matrix A_{c}, the corrected star vectors v_{ic}, the measured star vectors vᵢ and the number of stars N in the field of vision of the star tracker. Due to the very small deviations between the vectors vᵢ and v_{ic}, constellations can be identified with the vectors vᵢ or v_{ic}.

Processed data is transmitted on the second data-processing level, which is preferred for the data exchange between the star trackers. The constellations have to be identified in order for this data to be generated. Expressions are calculated that are employed to perform the QUEST algorithm. The advantage of this type of data exchange is the reduced effort involved in the transmission via the signal connection while, at the same time, achieving an accuracy that is comparable to that of data of the first data-processing level.

Since the orientation is calculated in star trackers according to the so-called QUEST algorithm, the data preprocessing can be carried out on the second data-processing level, for instance, as follows:

The elements of a quaternion vector q that depicts the orientation of a tracker system are obtained from the eigenvalue of the 4×4 matrix K:

$$\begin{matrix}K = ( \begin{matrix}S - I σ & Z \\ {Z}^{′} & σ\end{matrix} ) \\ with & ( 2 ) \\ B = {\sum }_{i} {v}_{i} \cdot {w}_{i}^{′} & ( 3 ) \\ S = {B}^{′} + B & ( 4 ) \\ σ = trace ( B ) & ( 5 ) \\ Z = {\sum }_{i} {v}_{i} \times {w}_{i} & ( 6 )\end{matrix}$$

and the 3×3 unit matrix I.

Using the correction matrix A_{c}, equations (3) and (6) then make a transition to the following form for the tracker that is to be corrected:

$$\begin{matrix}B = {\sum }_{i} {A}_{c} {v}_{i} \cdot {w}_{i}^{′} & ( 7 ) \\ Z = {\sum }_{i} ( {A}_{c} {v}_{i} ) \times {w}_{i} . & ( 8 )\end{matrix}$$

The 3×3 matrix B and the vector Z contain the measured star vectors vᵢ, the associated reference vectors wᵢ from the star catalog and the correction matrix A_{c}. Due to the additive linking of the star vectors in equations (7) and (8), the matrix B and the vector Z can be used as interface quantities of the second data-processing level as preprocessed star vectors and can transmitted via the bus system:

B=ΣB_{K} (9)

Z=ΣZₖ. (10)

Bₖ and Zₖ are the data of the k^{th} star tracker. In this manner, the accuracy of the star vector linking remains the same as compared to the first data-processing level, translating into a smaller number of variables and thus less transmission effort.

On a third data-processing level, the orientation information is provided in the form of Euler angles and/or quaternions by each individual star tracker and then transformed into the master coordinate system and/or into the coordinate system of the flying object. This data can likewise be transmitted via the bus system. Due to the high accuracy, the calculated Euler angles and/or quaternions of the individual star trackers generally deviate only slightly from each other.

The quaternion vector contains four elements. Since the representation of the orientation only requires three elements, there is an additional condition. This additional condition has to be taken into consideration in all of the calculations.

Therefore, in order to determine the amount by which the measured results of the star tracker that is to be corrected deviate from those of the master tracker, the product rule has to be used for linking the quaternions,

$$Δ {q}_{A} = ( \begin{matrix}{q}_{A 24} & - {q}_{A 23} & {q}_{A 22} & - {q}_{A 21} \\ {q}_{A 23} & {q}_{A 24} & - {q}_{A 21} & - {q}_{A 22} \\ - {q}_{A 22} & {q}_{A 21} & {q}_{A 24} & - {q}_{A 23} \\ {q}_{A 21} & {q}_{A 22} & {q}_{A 23} & {q}_{A 24}\end{matrix} ) {q}_{A 1} , \qquad ( 11 )$$

with the quaternion vector q_{A1}=(q_{A11} q_{A12} q_{A13} q_{A14})′ at the output of the master tracker or reference tracker, with the output vector q_{A2}=(q_{A21} q_{A22} q_{A23} q_{A24})′ of the star tracker that is to be adapted, and with the differential vector Δq_{A}.

The quaternion vector q_{A1} has the function of the target value in the adaptation loop. The quaternion vector Δq_{A} indicates the rule deviation for the adaptation, which is minimized over the course of the adaptation process. Owing to the very small deviations of the orientations measured by the master tracker from those measured by the tracker that is to be corrected, the element Δq_{A4} is always almost 1. Thus, the information needed for the adaptation process is in the elements Δq_{A1}, Δq_{A2}, Δq_{A3}.

The quaternion vector Δq_{A} indicates how the star tracker to be corrected has to be rotated in order for it to exhibit the same orientation as the reference tracker relative to the same coordinate system. With this vector, the orientation information for the information fusion can preferably be corrected on the above-mentioned three levels, namely, on the level of the star vector, on the level of the preprocessed orientation data, and on the level of output signal. By means of the quaternion vector Δq_{A}, an orientation matrix can be calculated with which the orientation information of the tracker that is to be corrected can then be processed. The vector Δq_{A} contains not only the useful information about the correction of the misalignment but also the measuring inaccuracies of the two trackers. For this reason, it is not meaningful to perform the correction in one step. A weighting factor w serves to realize a smoothing process. It ensures the stability of the adaptation process and is adapted to the speed of change of a misalignment. The orientation matrix A_{c} needed for the correction is calculated as follows. The starting point is formed by a unit matrix

$${A}_{c} ( 0 ) = ( \begin{matrix}1 & 0 & 0 \\ 0 & 1 & 0 \\ 0 & 0 & 1\end{matrix} ) . \qquad ( 12 )$$

In the subsequent steps, this matrix is modified with the elements of the error vector Δq_{A}, namely,

$${A}_{c} ( k + 1 ) = {A}_{c} ( k ) + w ( \begin{matrix}0 & 2 Δ {q}_{A 3} ( k ) & - 2 {Δ}_{A 2} ( k ) \\ - 2 Δ {q}_{A 3} ( k ) & 0 & 2 Δ {q}_{A 1} ( k ) \\ 2 Δ {q}_{A 2} ( k ) & - 2 Δ {q}_{A 1} ( k ) & 0\end{matrix} ) . \qquad ( 13 )$$

As a function of the number of measurement cycles k, the matrix A_{c}(k) approximates an optimal matrix for the correction of the misalignment. The elements—which differ from zero—of the matrix weighted with w constitute the Euler angles belonging to the quaternion vector Δq_{A}. Due to the very small Euler angles, deviations of the values of the main diagonals of the matrix A_{c}(k) of 1 can be considered as negligible.

The matrix has to be linked to the tracker signals of the three processing levels (star vector level, preprocessed signals, output signal level) in such a way that the effect of the misalignment of the tracker in question is diminished.

The relationships shown in equations (11) to (13) are obtained as follows: the orientation deviation calculated according to equation (11) is weighted with the scalar quantity 0<w<1 and added to the momentary values according to equation (12). The storage unit I (3×3) stores the momentary values of the matrix A_{c} by one cycle. The orientation correction matrix calculated in this manner is fed in a suitable manner to the star tracker S that is to be corrected, thus compensating for the effect of a misalignment described by the quaternion vector qₐ.

A flying object contains the star trackers that have been optimized to carry out the method and configured with an eye towards achieving high accuracy, low influence from scatter light, high mechanical strength, high radiation resistance, low energy consumption, low weight, sufficient computation capacity and a star catalog of a sufficient size. Preferably, star trackers having a field of vision of about 20°×20° or an orbicular field of vision of 20° are employed.

The networked star trackers of a tracker system for carrying out the proposed method can especially be used in the conventional manner in case of a failure of one or more of the star trackers or of the bus system.

### BRIEF DESCRIPTION OF THE DRAWINGS

The invention will be explained in greater detail in the embodiments shown in FIGS. 1 to 6. The following is shown:

FIG. 1: a schematic view relating to the correction of the effect of a misalignment of a star tracker, in which the measured orientations of the reference tracker (master tracker) and of the star tracker that is to be corrected are compared to each other in the same coordinate system, and the error signal is employed to compensate for the effect of the misalignment;

FIG. 2: a schematic view of the incremental generation of a correction orientation matrix A_{c} that serves to compensate for a misalignment described by the quaternion vector qₐ;

FIG. 3: a view on the basis of effective orientation matrices to compensate for the effect of a misalignment;

FIG. 4: a view on the basis of effective orientation matrices to compensate for the effect of a misalignment and the calculation of the orientation of the flying body of the star tracker system;

FIG. 5: a view on the basis of effective orientation matrices to compensate for the misalignment of several star trackers, and

FIG. 6: the example of a compensation procedure.

### DETAILED DESCRIPTION

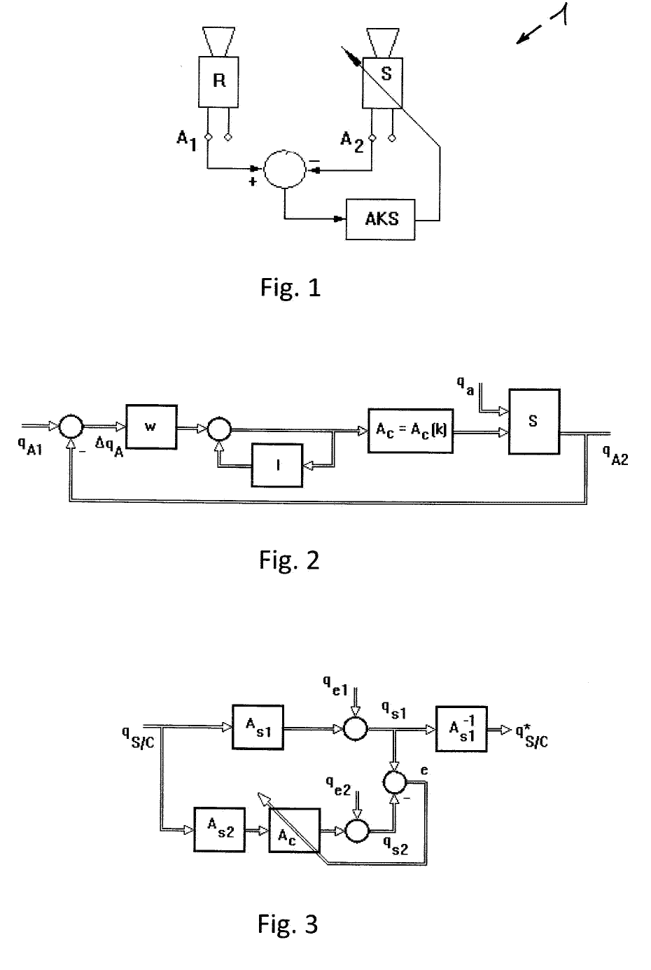

FIG. 1 also shows the tracker system 1 that has been installed in a flying object (not shown here) and that consists of two star trackers R, S. The star tracker R, which is attached to a platform (not shown here) of a flying object in a particularly stable manner, serves as the reference tracker. The star trackers R, S are aligned in different spatial directions. The output signals of the star trackers R, S, preferably in the form of quaternions, indicate the orientation of the star trackers R, S in a reference coordinate system, in the coordinate system of the reference tracker R or in a master coordinate system of the tracker system 1. If the star trackers R, S are functioning properly, approximately the same orientation data should be obtained at the outputs A1 and A2 relative to the master coordinate system. In order for the star tracker system 1 to attain its full accuracy, it is necessary to compensate for a possible misalignment of the star tracker S. For this purpose, orientation deviations of both star trackers R, S are compared and an error signal, for instance, in the form of the difference of the orientations, is used to mechanically or preferably electronically compensate for the orientation error. The ACS (adaptive compensation system) module serves to generate the correction signal. In order to obtain a stable measurement, the compensation is carried out in sufficiently small increments.

FIG. 2 shows how, on the basis of the orientation deviation, the correction orientation matrix A_{c} is formed according to equation (11) from the quaternion vector q_{A1} of the reference tracker and from the quaternion vector q_{A2} of the star tracker that is to be corrected. The orientation deviation calculated according to equation (11) is weighted with the scalar quantity 0<w<1 and added to the momentary values according to equation (12). The storage unit I stores the momentary values of the matrix A_{c} by one cycle. The orientation correction matrix calculated in this manner is fed in a suitable manner to the star tracker S that is to be corrected, thus compensating for the effect of a misalignment described by the quaternion vector qₐ.

The differential vector Δq_{A} is used recursively according to equation (13) in order to build up an orientation matrix A_{c} that influences the coordinate system or the star vectors or the preprocessed tracker signals or the output signal of the star tracker S in such a way that the effect of a possible misalignment described by the quaternion qₐ is diminished.

FIG. 3 describes the signal flows by means of the quaternions. The orientation of the flying object, expressed by the quaternion q_{S/C}, yields orientation information in the reference tracker in the form of the quaternion vector qₛ₁ of the reference tracker in the coordinate system of the reference tracker or in the master coordinate system of the star tracker system 1. This quaternion vector results from the transformation Aₛ₁ of the coordinate systems of the flying object and of the master tracker and from an error vector qₑ₁. The transformation of the measured quaternion vector qₛ₁ with the inverse orientation matrix Aₛ₁⁻¹ yields the measured orientation in the form of the measured quaternion q_{S/C}*. Analogously to this, the quaternion vector qₛ₂ is generated in a second star tracker. The orientation matrix A_{c} is generated on the basis of the orientation deviation e=Δq_{A}. This orientation matrix A_{c} brings about a compensation of the deviations between the two star trackers, so that the resulting orientation matrices approach each other, displaying the tendency A_{c}·Aₛ₂→Aₛ₁.

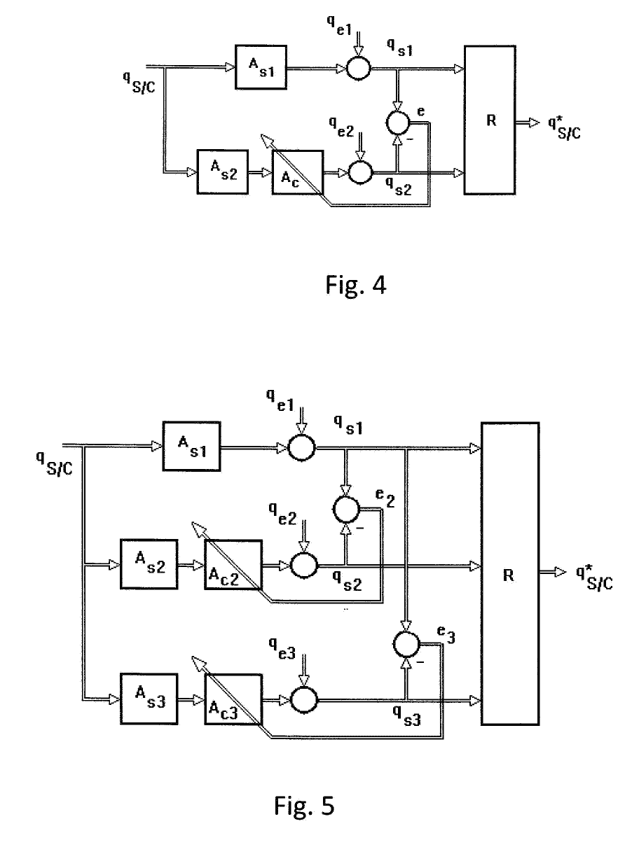

FIG. 4 shows one possibility of linking the measured orientation of the two star trackers in order to enhance the measuring accuracy in a star tracker system. The linking can be carried out on the output level (as shown), on the level of preprocessed orientation signals, or on the level of star vectors.

FIG. 5, like FIG. 4, shows a star tracker system consisting of three star trackers.

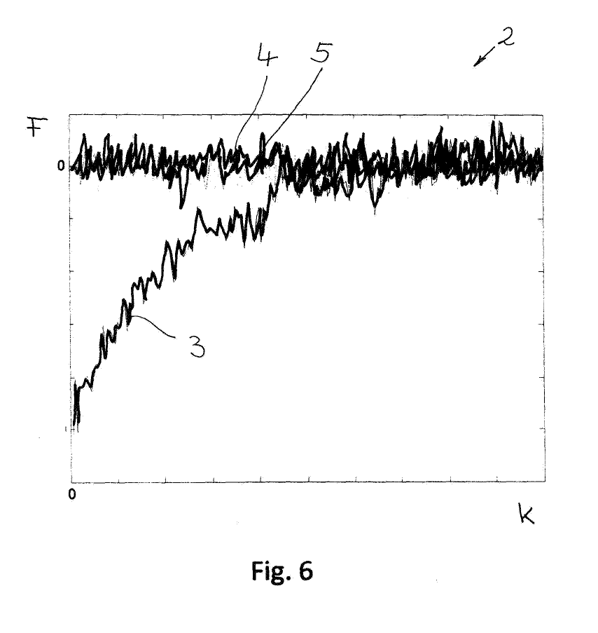

On the basis of diagram 2, FIG. 6 shows the course of the compensation procedure for a star tracker system consisting of two star trackers in accordance with FIG. 1. Here, the alignment error F of the star tracker S is plotted against a continuously performed error correction by means of the correction index k of correction cycles. The misalignment of the second star tracker S brings about a rolling error of about 10 arc seconds as shown in curve 3. Owing to the geometric arrangement of the star trackers with respect to each other, the pitch errors in curve 4 and the yaw errors in curve 5 behave almost indifferently. Over the course of the correction cycles, this rolling error is diminished so that, after the adaptation procedure, the star tracker system 1 has approximately the same errors in the pitch, yaw and rolling component of the orientation. Here, the fusion of the tracker data was carried out on the level of the star vector. All of the star trackers of the star tracker system are preferably structured identically but, depending on actual-practice experience, some modules can be switched off or not be implemented, for example, in order to save energy.

### LIST OF REFERENCE NUMERALS

1 star tracker system
2 diagram
3 curve
4 curve
5 curve
A₁ output
A₂ output
A_{c} orientation matrix
A_{c}(k) orientation matrix dependent on a correction cycle index k
A_{c2} orientation matrix
A_{c3} orientation matrix
A_{S1} transformation
A_{S2} transformation
A_{S3} transformation
Aₛ₁⁻¹ inverse orientation matrix
ACS module
e orientation deviation
e₂ orientation deviation
e₃ orientation deviation
F alignment error
k correction index
I storage unit
qₐ quaternion vector of a misalignment
q_{A1} quaternion vector of the reference tracker
q_{A2} quaternion vector of the star tracker that is to be corrected
qₐ₁ orientation vector of the reference tracker
qₐ₂ orientation vector of the star tracker that is to be corrected
qₑ₁ error vector of the reference tracker
qₑ₂ error vector of the star tracker that is to be corrected
qₑ₃ error vector of the star tracker that is to be corrected
qₛ₁ quaternion vector of the reference tracker
qₛ₂ quaternion vector of the star tracker that is to be corrected
qₛ₃ quaternion vector of the star tracker that is to be corrected
q_{S/C} quaternion
q_{S/C}* measured quaternion
R star tracker (reference tracker)
S star tracker (star tracker that is to be corrected)
w weighting factor
Δq_{A} differential vector

What is claimed is:

1-8. (canceled)

9: A method for the automatic correction of alignment errors in star trackers of a star tracker system for determining the orientation of a flying object, the star tracker system including several star trackers arranged on a platform and an evaluation unit for orientation information from the star trackers, the method comprising:
providing a first of the star trackers as a reference tracker;
employing an orientation determined by the reference tracker as reference information;
continuously ascertaining an error signal between the reference information and the orientation information of at least one additional star tracker of the star trackers; and
correcting an orientation error of the at least one additional star tracker with the ascertained error signal.

10: The method as recited in claim 9 wherein the reference tracker is arranged so as to be stable with respect to the at least one additional star tracker.

11: The method as recited in claim 9 further comprising depicting the reference information and the orientation information of the at least one additional star tracker in a master coordinate system, the error signal being ascertained in the master coordinate system and transferred back to the coordinate system of the at least one additional star tracker.

12: The method as recited in claim 9 wherein, if the error signal of the at least one additional star tracker is present, a mechanical correction of the at least one additional star tracker that is erroneous is carried out.

13: The method as recited in claim 9 wherein, if the error signal of the at least one additional star tracker is present, a correction of the orientation information of the at least one additional star tracker is carried out on a processing level of star vectors.

14: The method as recited in claim 9 wherein, if the error signal of the at least one additional star tracker is present, a correction of the orientation information at least one additional star tracker is carried out on a level of preprocessed star vectors.

15: The method as recited in claim 9 wherein, if the error signal of the at least one additional star tracker is present, a correction of the orientation information of the at least one additional star tracker is carried out on a level of the Euler angle and/or on a level of the quaternions.

16: The method as recited in claim 9 wherein a correction of the alignment on the basis of the ascertained error signals continues to be carried out until the value has fallen below a prescribed error deviation of the orientation information between the reference tracker and the at least one additional star tracker.

17: The method as recited in claim 9 wherein, in the case of at least two of the star trackers being erroneous, a correction quantity obtained from a comparison of a given one of the star trackers to the reference tracker is used for the appertaining additional star tracker for purposes of its additional correction.
